(19) United States
(12) Patent Application Publication
(10) Pub. No.: US 2015/0341463 A1
(43) Pub. Date: Nov. 26, 2015

(54) CLIENT-SIDE FLIGHT VERSION ACQUISITION

(71) Applicant: Microsoft Corporation, Redmond, WA (US)

(72) Inventors: Ami Machluf, Herzeliya (IL); Yosef Dinerstein, Haifa (IL)

(73) Assignee: Microsoft Corporation, Redmond, WA (US)

(21) Appl. No.: 14/284,898

(22) Filed: May 22, 2014

(51) Int. Cl. H04L 29/08; G06F 9/445

(52) U.S. Cl. CPC H04L 67/306; H04L 67/1095; H04L 67/18; G06F 8/60

(57) ABSTRACT

One or more techniques and/or systems are provided for client-side flight version acquisition. For example, a client-side deployment component, hosted on a client device, may identify an application package available for retrieval (e.g., a shopping application package) from a remote source. A flight description for the application package may be evaluated using a user authorized client context (e.g., a gender and age of a user) to identify a qualifying flight version of the application package (e.g., a teenage female version of the shopping application package). The flight version may be acquired from the remote source, and may be deployed on the client device. Performing client-side flight version selection and acquisition may improve privacy of user data (e.g., by maintaining the client context on the client device) and may offload processing from the remote source (e.g., an app distribution service that may service a plethora of client devices).

### BACKGROUND

Many users perform tasks using a variety of applications hosted by client devices. In an example, a user may map driving directions using a map application. In another example, the user may plan a social party using a social network application. Such applications may be deployed from a remote source, such as an app store, onto a client device.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for client-side flight version acquisition are provided. A remote source, such as an app store, may expose a variety of application packages for acquisition by client devices. For example, a clothes shopping application package, a videogame application package, a social network application package, and/or a wide variety of application packages may be exposed by the remote source as application packages, which may be used to deploy/install applications on client devices. One or more flight versions of an application package may be available from the remote source. For example, a female oriented flight version of the clothes shopping application package, a male oriented flight version of the clothes shopping application package, a teenager oriented flight version of the clothes shopping application, and/or other flight versions of the clothes shopping application package may be available.

A client-side deployment component may be hosted on a client device. The client-side deployment component may be configured to execute client-side functionality for selectively identifying, acquiring, and/or deploying a qualifying flight version of an application package to the client device based upon a client context (e.g., a gender, location, occupation, etc. of the user may be used to select a flight version of the clothes shopping application package that may be relevant to the user), which may improve privacy of user data (e.g., a social network profile, a device location, email data, and/or other user data that the user has opted-in to allow the client-side deployment component to access) and/or may offload processing from the remote source to client devices. The available flight versions of the application package may be customized and/or tailored for various types of users, and thus the client context may be used to select the qualifying flight version from among the available flight versions of the application package (e.g., a female flight version may be customized with female oriented merchandise; a teenage flight version may be customized with teenager oriented merchandise; etc.). In an example, the user may take affirmative action to provide opt-in consent to allow access to user data for identifying the client context.

In an example, an application package available for retrieval, such as the clothes shopping application package, may be identified from the remote source. A flight description for the clothes shopping application package may be retrieved. The flight description may comprise sets of flight distribution criteria for flight versions of the clothes shopping application package (e.g., a Germany location criteria, a female criteria, and a healthcare worker criteria may be specified for a first flight version; a male criteria may be specified for a second flight version; a United States location criteria and a female criteria may be specified for a third flight version; etc.). A set of filtering modules (e.g., a location filtering module, a gender filtering module, an occupation filtering module, etc.) may be invoked to filter the flight description based upon a client context to identify a qualifying flight version of the clothes shopping application package. For example, the gender filtering module may filter/disqualify the second flight version because the user is a female as opposed to being a male. The location filtering module may filter/disqualify the first flight version because the user is located in the United States as opposed to Germany. The qualifying flight version may be identified as the third flight version because the flight distribution criteria of the third flight version may be satisfied by the client context. Accordingly, the third flight version of the clothes shopping application package may be acquired from the remote source, and maybe deployed on the client device.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of client-side flight version acquisition.

FIG. 2 is an illustration of an example of a remote source configured to expose one or more application packages for selective retrieval by client devices.

FIG. 3 is a component block diagram illustrating an exemplary system for identifying a client context.

FIG. 4A is a component block diagram illustrating an exemplary system for client-side flight version acquisition.

FIG. 4B is a component block diagram illustrating an exemplary system for client-side flight version acquisition and deployment.

FIG. 5A is a component block diagram illustrating an exemplary system for client-side flight version acquisition.

FIG. 5B is a component block diagram illustrating an exemplary system for client-side flight version acquisition and deployment.

FIG. 6A is a component block diagram illustrating an exemplary system for client-side flight version acquisition.

FIG. 6B is a component block diagram illustrating an exemplary system for client-side flight version acquisition and deployment.

FIG. 7 is an illustration of an exemplary computer readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for client-side flight version acquisition are provided herein. A client-side deployment component may be hosted on a client device. The client-side deployment component may identify an application package available for retrieval from a remote source (e.g., a real estate application package available from an app store). A flight description may be retrieved for the application package. The flight description may describe sets of flight distribution criteria for various flight versions of the application package (e.g., a home buyer distribution criteria may be specified for a home buyer flight version; a home seller distribution criteria may be specified for a home seller flight version; a real estate agent distribution criteria may be specified for a real estate agent version; etc.) Flight versions may be customized and/or tailored for particular users (e.g., the home seller flight version may comprise for sale by owner functionality; the home buyer flight version may comprise submit offer functionality; a real estate agent flight version may comprise agent listing functionality; etc.). A client context may be identified (e.g., a social network profile and an email address may indicate that the user is a real estate agent). A set of filtering modules may be invoked to filter the flight description based upon the client context to identify a qualifying flight version of the application package (e.g., the home seller flight version and the home buyer flight version may be filtered/disqualified based upon the client context indicating that the user is not buying or selling a personal home). Accordingly, the qualifying flight version (e.g., the real estate flight version) may be acquired from the remote source, and may be deployed on the client device. Where multiple versions of an application package are available as a qualifying flight version (e.g., are not filtered out by filtering modules), one or more of these versions may be acquired and/or deployed, such as based upon user selection (e.g., in response to a user prompt to select from a list of qualifying flight versions), respective weightings applied to qualifying flight versions (e.g., based upon client context, prior/historical data/behavior of the user and/or one or more other users, respective dates/freshness of qualifying flight versions, respective downloads/popularity of qualifying flight versions, respective reputations of providers of qualifying flight versions, respective sizes of qualifying flight versions, respective file types of qualifying flight versions, etc.) and/or a plethora of other considerations regarding whether to acquire and/or deploy particular qualifying flight versions. Client-side flight version acquisition may improve privacy of user data such as the client context and/or may offload processing from the remote source.

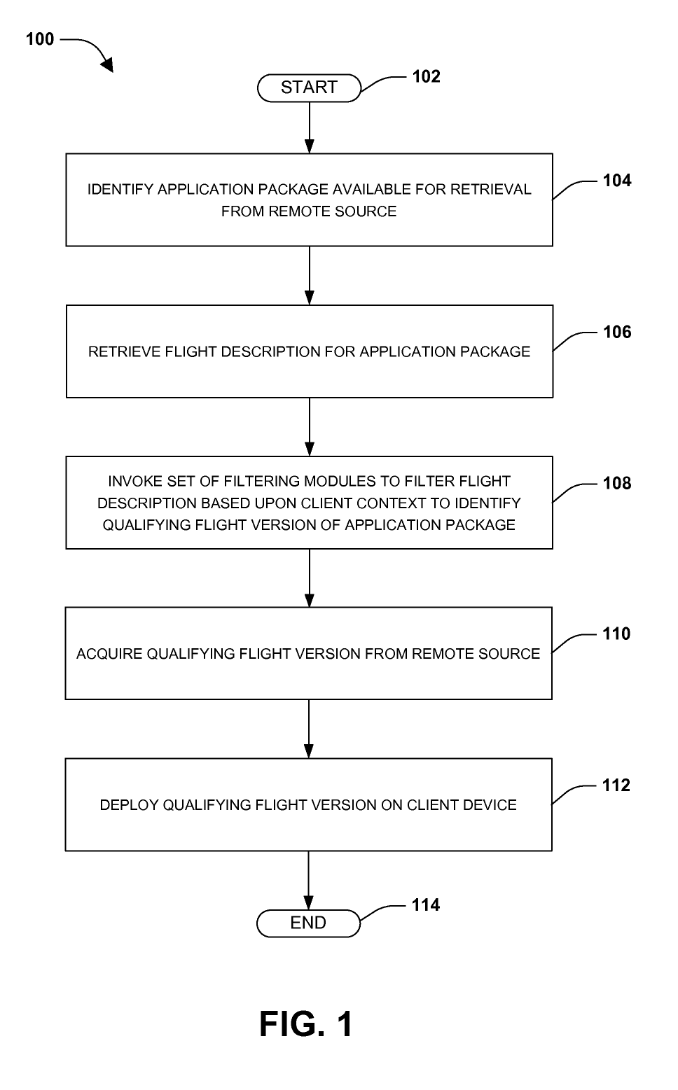

An embodiment of client-side flight version acquisition is illustrated by an exemplary method 100 of FIG. 1. At 102, the method starts. A remote source, such as an app deployment server (e.g., an app store), may expose a variety of application packages (e.g., a deployment package used to install an application on a client device) for selective acquisition by client devices. One or more flight versions of an application package may be available. A flight version may be tailored and/or customized for particular client devices and/or users (e.g., a vegan diet flight version of a restaurant application package; a no carb diet flight version of the restaurant application package; an over 21 drink flight version of the restaurant application package; etc.). Accordingly, a client-side deployment component, hosted on a client device (e.g., hosted by an operating system as an operating system component), may perform client-side flight version acquisition.

At 104, an application package, such as the restaurant application package, may be identified as being available for retrieval from the remote source. At 106, a flight description for the application package may be retrieved. The flight description may comprise sets of flight distribution criteria for various flight versions of the application package, such as a first set of flight distribution criteria for a first flight version and a second set of flight distribution criteria for a second flight version. For example, the flight description may specify a vegan diet flight distribution criteria for the vegan diet flight version, a no carb diet flight distribution criteria for the no carb diet flight version, a 21 or older age flight distribution criteria for the over 21 drink flight version, etc. In an example, one or more of the flight versions may be experimental versions of the application package, which may be retrieved by client devices for experimental/trial purposes.

At 108, a set of filtering modules may be invoked to filter the flight description based upon a client context to identify a qualifying flight version of the application package. The set of filter modules may comprise a variety of filtering modules, such as a gender filtering module, a device location filtering module, a device configuration filtering module, a user characteristic filtering module, a probabilistic filtering module, etc. In an example, the client context may be identified based upon a hardware configuration of the device (e.g., a CPU type, an amount of memory, touch input capabilities, screen resolution, a data plan for a mobile device, etc.), software configuration of the client device (e.g., an operating system type, installation of an app such as a diet app that may be indicative of foods that the user may be limited to eating, etc.), and/or descriptive user information of the user of the client device (e.g., a social network post indicating that the user has a food allergy, an email indicating that the user has an interest in Italian restaurants, gender, age, location, and/or a wide variety of information about the user). A user may take affirmative action to provide opt-in consent to allow access to user and/or other data for identifying the client context. In an example, the client context may be maintained on the client device and/or the remote source may be restricted from accessing the client context. Restricting disclosure of the client context may improve privacy of user data that is maintained locally on the client device.

The client context may be used by the set of filtering modules to filter the flight description to identify the qualifying flight version. The set of filtering modules may be executed on the client device, which may offload processing from the remote source. In an example, an age user characteristic filtering module may filter/disqualify the over 21 drink flight version based upon the user being younger than 21 years old. In another example, a diet user characteristic filtering module may filter/disqualify the vegan diet flight version based upon a social network profile indicating that the user is participating in a chicken protein with no carbs diet. In this way, the no carb flight version of the restaurant application package may be identified as the qualifying flight version because the no carb diet flight distribution criteria is satisfied by the client context. At 110, the qualifying flight version of the application package may be acquired from the remote source. At 112, the qualifying flight version of the application package may be deployed on the client device. For example, the no carb flight version of the restaurant application package may be installed on the client device. At 114, the method ends.

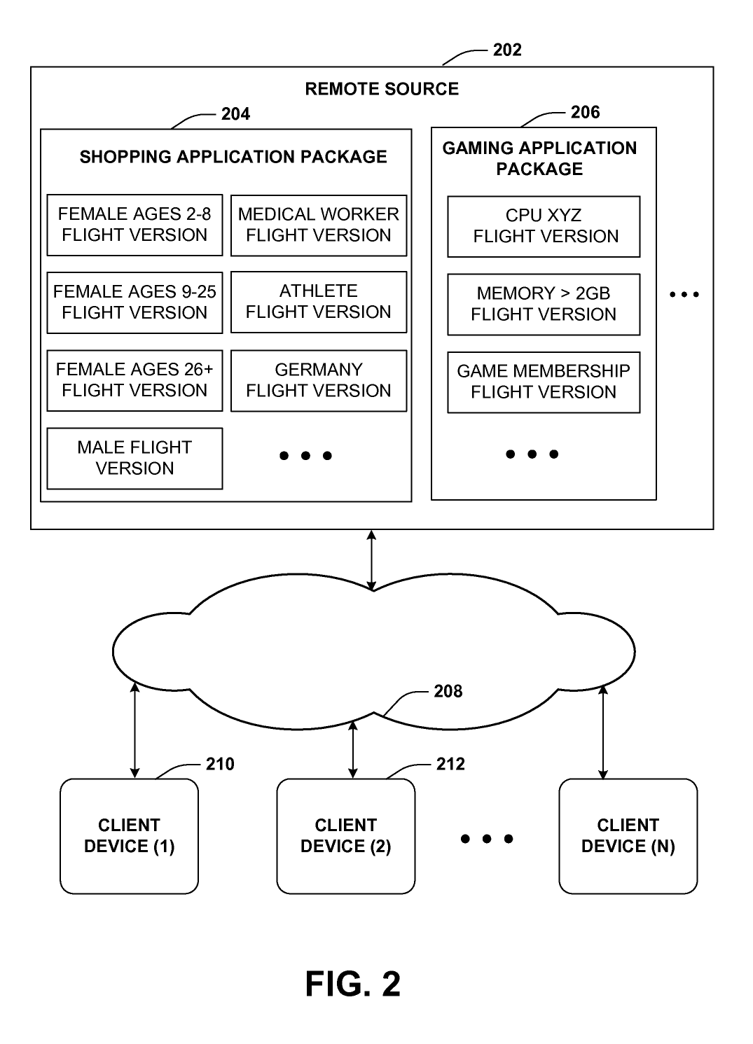

FIG. 2 illustrates an example of a remote source 202 configured to expose one or more application packages for selective retrieval by client devices. In an example, the remote source 202 exposes a shopping application package 204, a gaming application package 206, and/or a variety of other application packages for selective retrieval. One or more flight versions of the shopping application package 204 may be available, such as a female ages 2-8 flight version, a female ages 9-25 flight version, a female ages 26+ flight version, a male flight version, a medical worker flight version, an athlete flight version, a Germany flight version, etc. A shopping flight description for the shopping application package 204 may comprise sets of flight distribution criteria for the one or more flight versions (e.g., a female gender distribution criteria and an age 2-8 distribution criteria may be specified for the female ages 2-8 flight version; a medical worker occupation distribution criteria may be specified for the medical worker flight version; a Germany location distribution criteria may be specified for the Germany flight version; etc.). One or more client devices, such as a first client device 210 and a second client device 212, may selectively retrieve qualifying flight versions of application packages from the remote source 202 over a network 208 (e.g., the female ages 2-8 flight version may be retrieved by the first client device 210 based upon a client context indicating that a user of the first client device 210 is a 7 year old female, which may satisfy the female gender distribution criteria and the age 2-8 distribution criteria).

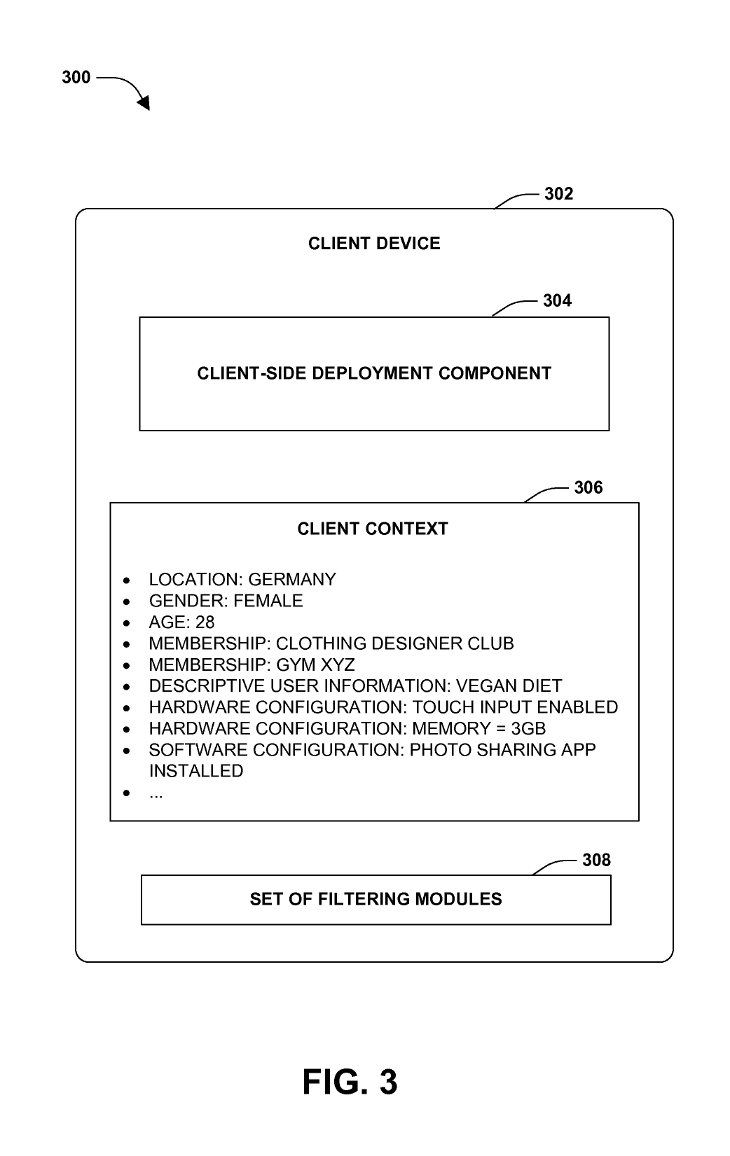

FIG. 3 illustrates an example of a system 300 for identifying a client context 306. The system 300 comprises a client-side deployment component 304 hosted by a client device 302. The client-side deployment component 304 may be configured to evaluate a variety of user signals (e.g., provided the user consents to the same) to identify the client context 306. For example, social network data, files, web browsing history, installed applications, client device hardware, emails, calendar entries, photos, and/or a variety of other user signal sources may be evaluated to determine the client context 306 as a location of Germany, a gender of female, an age of 28, a membership to a clothing designer club, a membership to a Gym XYZ, vegan diet descriptive user information, touch input enabled hardware configuration, 3 GB memory hardware configuration, a photo sharing app software configuration, and/or other information. A set of filtering modules 308 may utilize the client context 306 to filter a flight description of an application package to identify a qualifying flight version of the application package for acquisition and/or deployment from a remote source to the client device 302.

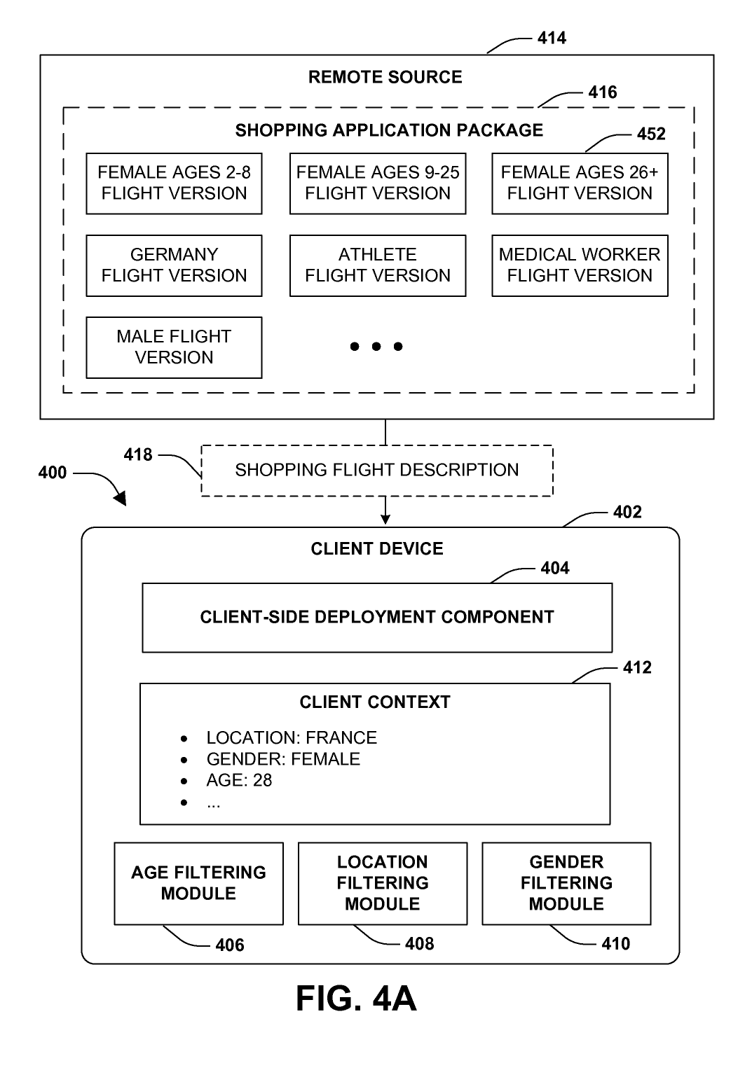

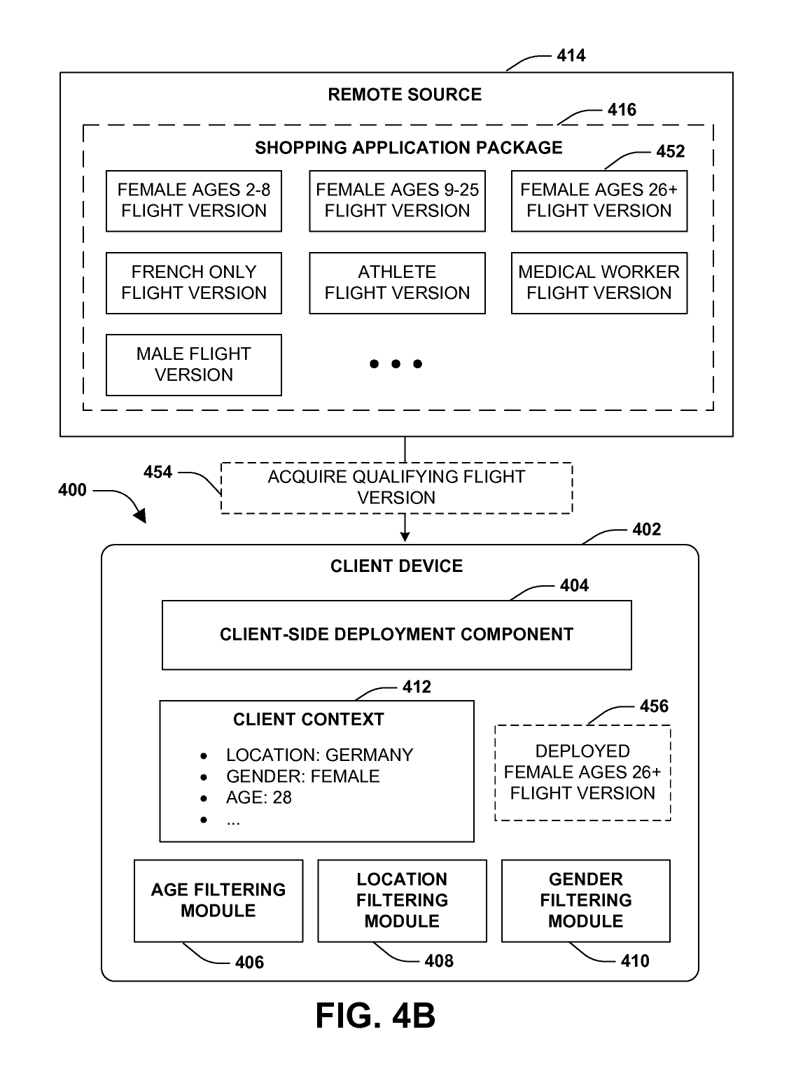

FIGS. 4A and 4B illustrate an example of a system 400 for client-side flight version acquisition. FIG. 4A illustrates the system 400 comprising a client-side deployment component 404. The client-side deployment component 404 may be hosted on a client device 402. The client-side deployment component 404 may be configured to identify an application package, such as a shopping application package 416, available from a remote source 414. The client-side deployment component 404 may obtain a shopping flight description 418 for the shopping application package 416. The shopping flight description 418 may comprise one or more sets of flight distribution criteria for flight versions of the shopping application package 416 (e.g., a female gender distribution criteria and an age 2-8 distribution criteria may be specified for a female ages 2-8 flight version; a medical worker occupation distribution criteria may be specified for a medical worker flight version; a Germany location distribution criteria may be specified for a Germany flight version; etc.).

The client-side deployment component 404 may be configured to identify a client context 412 based upon a hardware configuration of the client device 402, a software configuration of the client device 402, and/or descriptive user information of a user of the client device 402 (e.g., a France location, a female gender, a 28 year old age, etc.) (e.g., where the user has consented to use of the same). The client-side deployment component 404 may invoke a set of filtering modules, such as an age filtering module 406, a location filtering module 408, a gender filtering module 410, an occupation filtering module, and/or other filtering modules, to filter the shopping flight description 418 using the client context 412 to identify a qualifying flight version of the shopping application package 416. For example, the age filtering module 406 may filter/disqualify the female ages 2-8 flight version and a female ages 9-25 flight version because the user is 28 years old. The location filtering module 408 may filter/disqualify the Germany flight version because the user is located in France. The gendering filtering module 410 may filter/disqualify a male flight version because the user is female. The occupation filtering module may filter/disqualify an athlete flight version and the medial worker flight version because the user is not an athlete and is not a medical worker. In this way, a female ages 26+ flight version 452 may be identified as the qualifying flight version of the shopping application package 416 based upon the client context 412 satisfying a set of flight distribution criteria for the female ages 26+ flight version 452.

FIG. 4B illustrates the client-side deployment component 404 acquiring 454 the qualifying flight version of the shopping application package 416, such as the female ages 26+ flight version 452. The female ages 26+ flight version 452 may be deployed on the client device 402 as a deployed female ages 26+ flight version 456. The deployed female ages 26+ flight version 456 may correspond to a version of the shopping application package 416 that is customized and/or tailored for the user of the client device 402. In this way, client-side flight version acquisition may be performed.

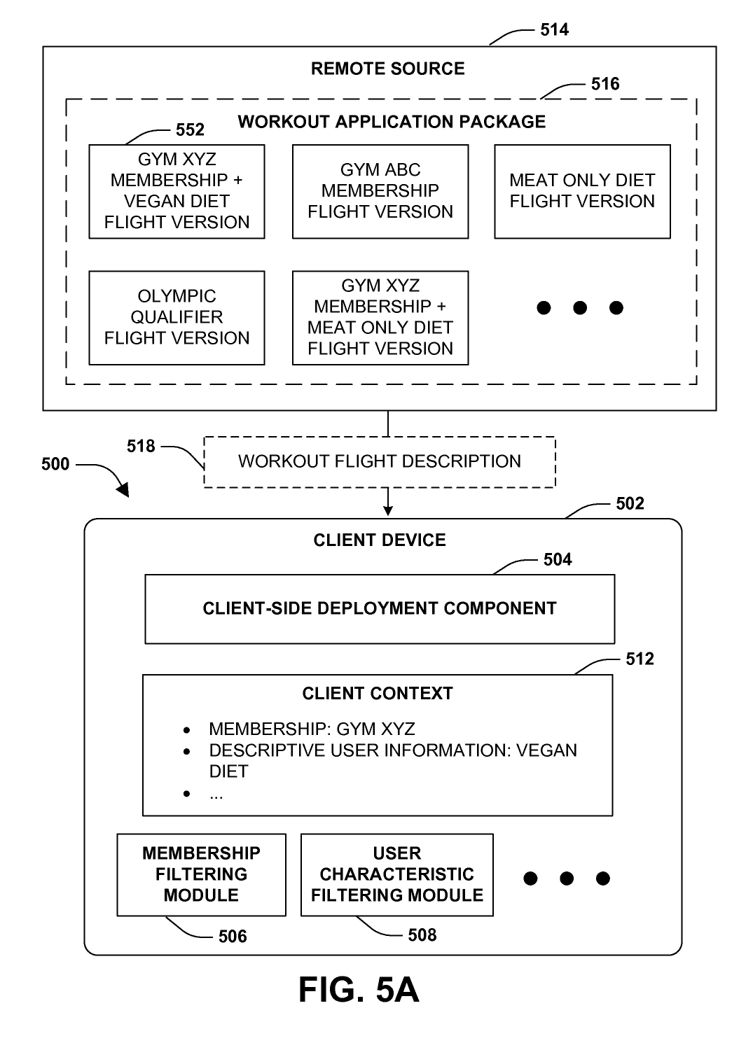

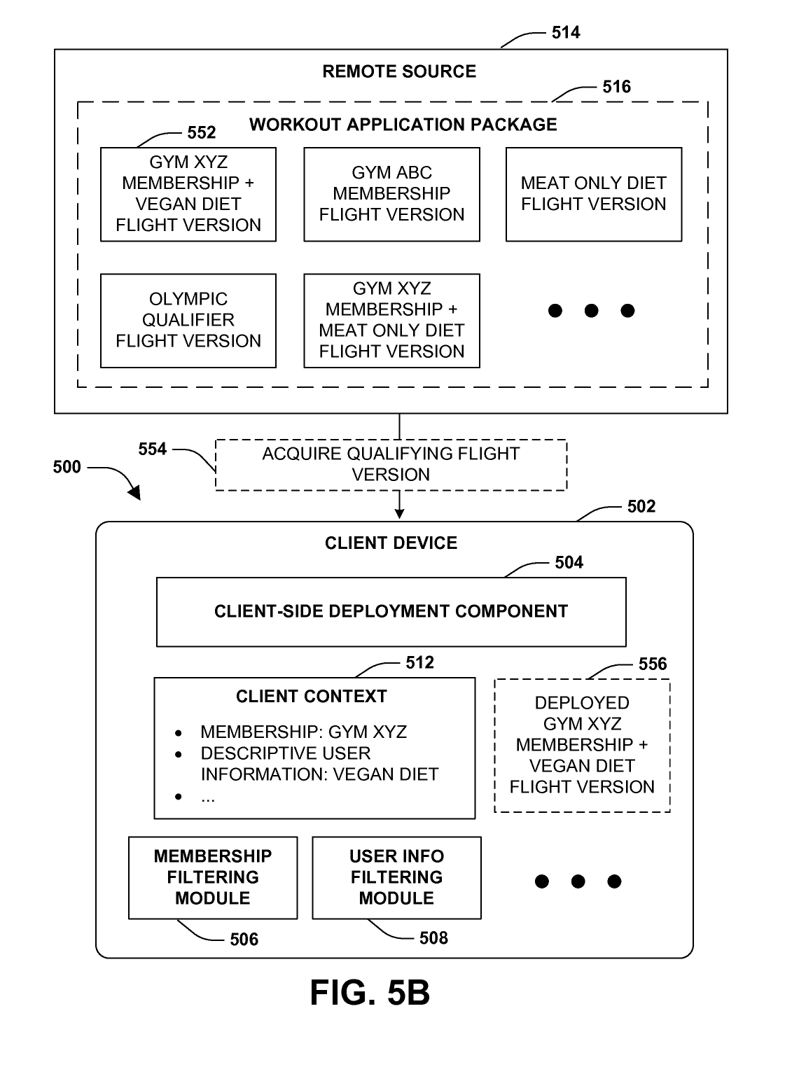

FIGS. 5A and 5B illustrate an example of a system 500 for client-side flight version acquisition. FIG. 5A illustrates the system 500 comprising a client-side deployment component 504. The client-side deployment component 504 may be hosted on a client device 502. The client-side deployment component 504 may be configured to identify an application package, such as a workout application package 516, available from a remote source 514. The client-side deployment component 504 may obtain a workout flight description 518 for the workout application package 516. The workout flight description 518 may comprise one or more sets of flight distribution criteria for flight versions of the workout application package 516 (e.g., a Gym XYZ membership distribution criteria and a vegan diet distribution criteria may be specified for a Gym XYZ vegan diet flight version 552; a Gym ABC membership distribution criteria may be specified for a Gym ABC membership flight version; a meat only diet distribution criteria may be specified for a meat only diet flight version; an Olympic qualifier distribution criteria may be specified for an Olympic qualifier flight version; a Gym XYZ membership distribution criteria and a meat only diet distribution criteria may be specified for a Gym XYZ meat only diet flight version, etc.).

The client-side deployment component 504 may be configured to identify a client context 512 based upon a hardware configuration of the client device 502, a software configuration of the client device 502, and/or descriptive user information of a user of the client device 502 (e.g., a Gym XYZ membership, a vegan diet, etc.) (e.g., where the user has consented to use of the same). The client-side deployment component 504 may invoke a set of filtering modules, such as a membership filtering module 506, a user characteristic filtering module 508, an occupation filtering module, and/or other filtering modules, to filter the workout flight description 518 using the client context 512 to identify a qualifying flight version of the workout application package 516. For example, the membership filtering module 506 may filter/disqualify the Gym ABC membership flight version because the user is not a member of Gym ABC. The user characteristic filtering module 508 may filter the meat only diet flight version and the Gym XYZ meat only diet flight version because the user is on a vegan diet. The occupation filtering module may filter/disqualify the Olympic qualifier flight version because the user is not an Olympic qualifier. In this way, the Gym XYZ vegan diet flight version 552 may be identified as the qualifying flight version of the workout application package 516 based upon the client context 512 satisfying a set of flight distribution criteria for the Gym XYZ vegan diet flight version 552.

FIG. 5B illustrates the client-side deployment component 504 acquiring 554 the qualifying flight version of the workout application package 516, such as the Gym XYZ vegan diet flight version 552. The Gym XYZ vegan diet flight version 552 may be deployed on the client device 502 as a deployed Gym XYZ vegan diet flight version 556. The deployed Gym XYZ vegan diet flight version 556 may correspond to a version of the workout application package 516 that is customized and/or tailored for the user (e.g., workout plans may be tailored to equipment available at the Gym XYZ and/or meal plans may be tailored for vegans). In this way, client-side flight version acquisition may be performed.

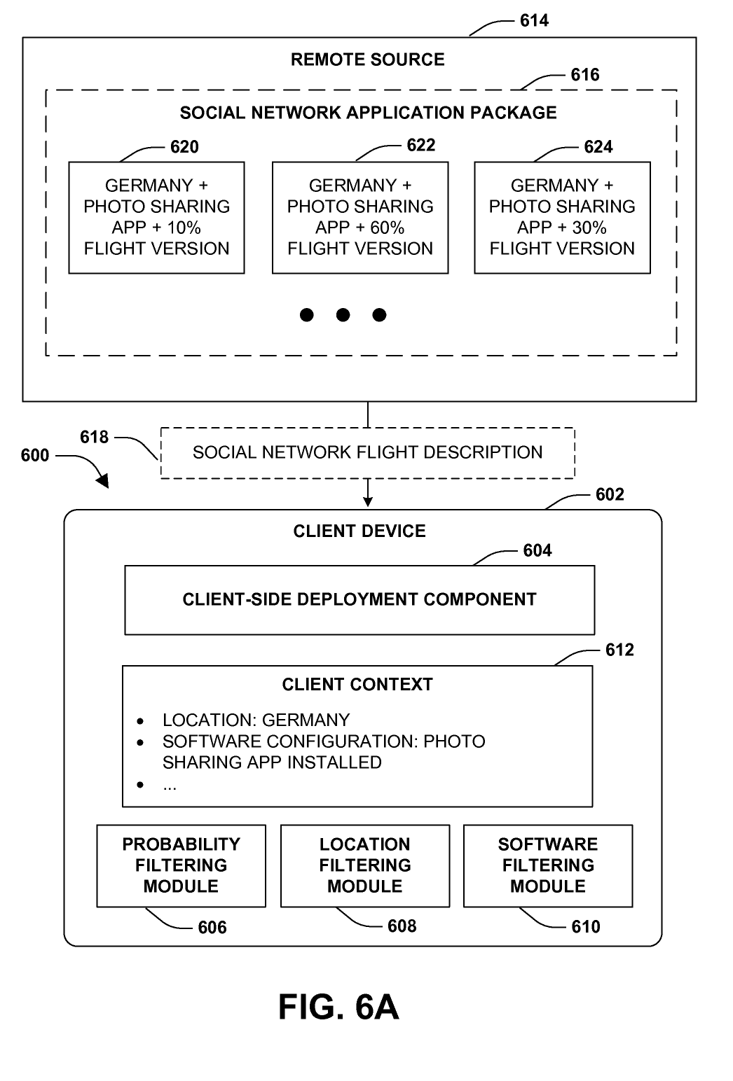

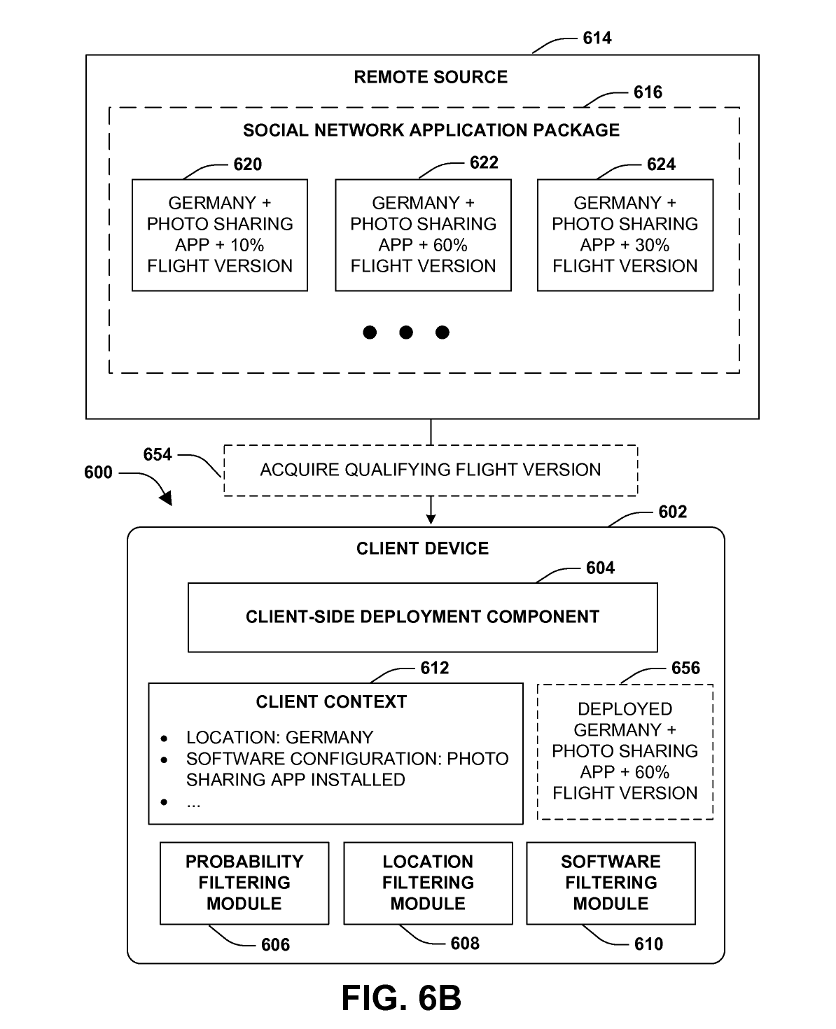

FIGS. 6A and 6B illustrate an example of a system 600 for client-side flight version acquisition. FIG. 6A illustrates the system 600 comprising a client-side deployment component 604. The client-side deployment component 604 may be hosted on a client device 602. The client-side deployment component 604 may be configured to identify an application package, such as a social network application package 616, available from a remote source 614. The client-side deployment component 604 may obtain a social network flight description 618 for the social network application package 616. The social network flight description 618 may comprise one or more sets of flight distribution criteria for flight versions of the social network application package 616 (e.g., a Germany location distribution criteria, a photo sharing app distribution criteria, and a 10% distribution criteria may be specified for a Germany photo sharing app 10% flight version 620; a Germany location distribution criteria, a photo sharing app distribution criteria, and a 60% distribution criteria may be specified for a Germany photo sharing app 60% flight version 622; a Germany location distribution criteria, a photo sharing app distribution criteria, and a 30% distribution criteria may be specified for a Germany photo sharing app 30% flight version 624, etc.).

The client-side deployment component 604 may be configured to identify a client context 612 based upon a hardware configuration of the client device 602, a software configuration of the client device 602, and/or descriptive user information of a user of the client device 602 (e.g., a Germany location, a photo sharing app installed on the client device 602, etc.) (e.g., where the user has consented to use of the same). The client-side deployment component 604 may invoke a set of filtering modules, such as a probability filtering module 606, a location filtering module 608, and a software filtering module 610, to filter the social network flight description 618 using the client context 612 to identify a qualifying flight version of the social network application package 616. For example, the Germany photo sharing app 10% flight version 620, the Germany photo sharing app 60% flight version 622, and the Germany photo sharing app 30% flight version 624 are not filtered out by the location filtering module 608 and the software filtering module 610 because the client device 602 is located in Germany and the photo sharing app is installed on the client device 602. The probability filtering module 606 may be configured to probabilistically select a flight version based upon the 10% distribution criteria, the 60% distribution criteria, and the 30% distribution criteria. For example, the probability filtering module 606 may probabilistically select the Germany photo sharing app 60% flight version 622 as the as the qualifying flight version. Because the probability filtering module 606 may utilize the distribution criteria specified in the social network flight description 618 (e.g., a 10% selection weight may be applied to the Germany photo sharing app 10% flight version 620, a 60% selection weight may be applied to the Germany photo sharing app 60% flight version 622, and a 30% selection weight may be applied to the Germany photo sharing app 30% flight version 624), the probability filtering module 606 may locally emulate such a distribution probability with respect to the client device 602 (e.g., such that 620 would be selected 10% of the time, 622 would be selected 60% of the time and 624 would be selected 30% of the time). In this way, the Germany photo sharing app 60% flight version 622 may be identified as the qualifying flight version of the social network application package 616.

FIG. 6B illustrates the client-side deployment component 604 acquiring 654 the qualifying flight version of the social network application package 616, such as the Germany photo sharing app 60% flight version 622. The Germany photo sharing app 60% flight version 622 may be deployed on the client device 602 as a deployed Germany photo sharing app 60% flight version 656. The deployed Germany photo sharing app 60% flight version 656 may correspond to a version of the social network application package 616 that may be customized and/or tailored for the user (e.g., a German language version that utilizes the photo sharing app to enable photo sharing). In this way, client-side flight version acquisition may be performed.

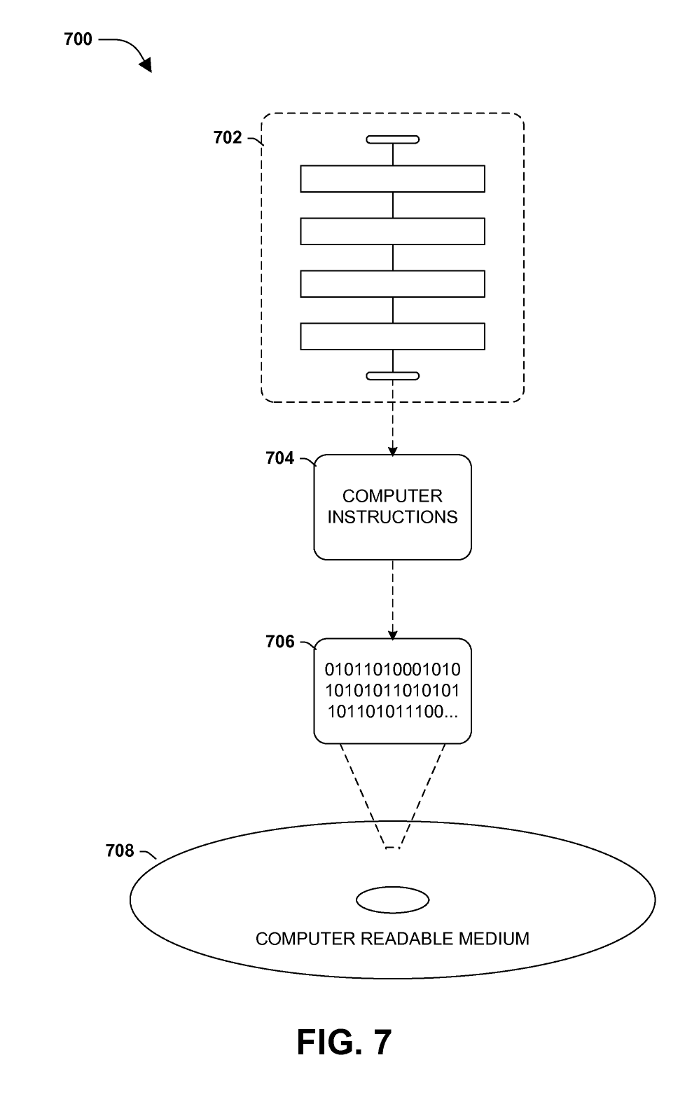

Still another embodiment involves a computer-readable medium comprising processor-executable instructions configured to implement one or more of the techniques presented herein. An example embodiment of a computer-readable medium or a computer-readable device is illustrated in FIG. 7, wherein the implementation 700 comprises a computer-readable medium 708, such as a CD-R, DVD-R, flash drive, a platter of a hard disk drive, etc., on which is encoded computer-readable data 706. This computer-readable data 706, such as binary data comprising at least one of a zero or a one, in turn comprises a set of computer instructions 704 configured to operate according to one or more of the principles set forth herein. In some embodiments, the processor-executable computer instructions 704 are configured to perform a method 702, such as at least some of the exemplary method 100 of FIG. 1, for example. In some embodiments, the processor-executable instructions 704 are configured to implement a system, such as at least some of the exemplary system 300 of FIG. 3, at least some of the exemplary system 400 of FIGS. 4A and 4B, at least some of the exemplary system 500 of FIGS. 5A and 5B, at least some of the exemplary system 600 of FIGS. 6A and 6B, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

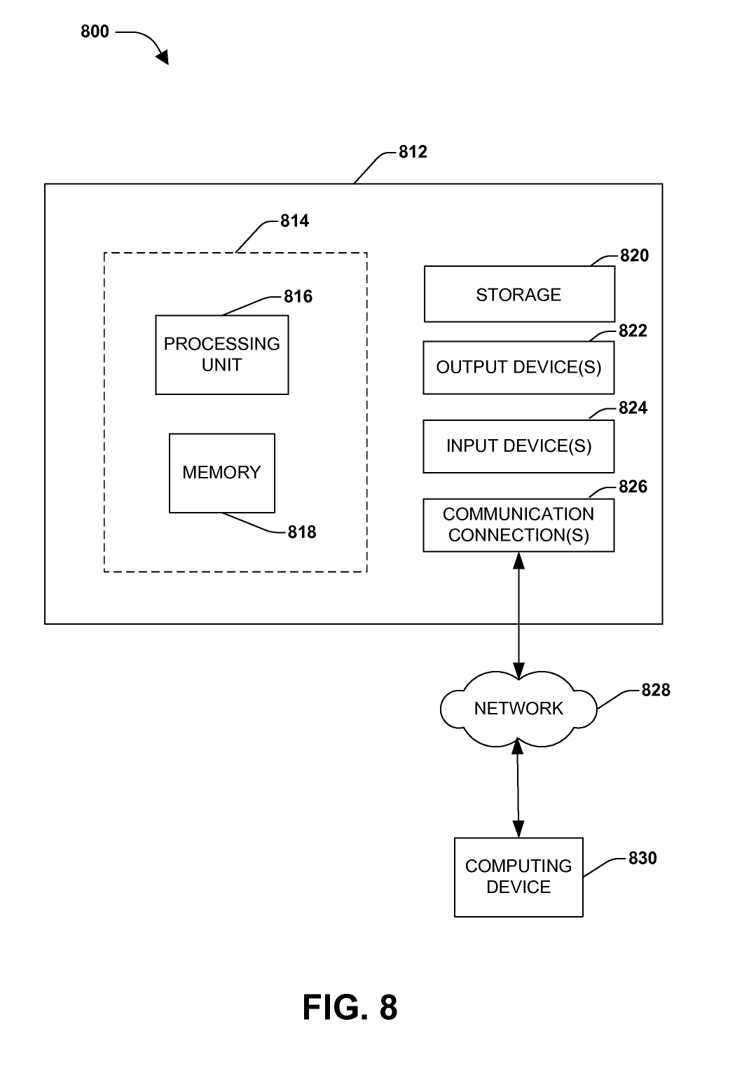

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Computer storage media does not, however, include propagated signals. Rather, computer storage media excludes propagated signals. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for client-side flight version acquisition, comprising:
a client-side deployment component, hosted on a client device, configured to:
identify an application package available for retrieval from a remote source;
retrieve a flight description for the application package, the flight description comprising a first set of flight distribution criteria for a first flight version of the application package and a second set of flight distribution criteria for a second flight version of the application package;
invoke a set of filtering modules to filter the flight description based upon a client context to identify a qualifying flight version of the application package;
acquire the qualifying flight version of the application package from the remote source; and
deploy the qualifying flight version of the application package on the client device.

2. The system of claim 1, the client-side deployment component configured to:
identify the client context based upon at least one of a hardware configuration of the client device, a software configuration of the client device, or descriptive user information of a user of the client device.

3. The system of claim 1, the set of filtering modules comprising a user gender filtering module.

4. The system of claim 1, the set of filtering modules comprising a device location filtering module.

5. The system of claim 1, the set of filtering modules comprising a device configuration filtering module.

6. The system of claim 1, the set of filtering modules comprising a user characteristic filtering module.

7. The system of claim 1, the set of filtering modules comprising a probabilistic filtering module.

8. The system of claim 1, the client-side deployment component configured to invoke the set of filtering modules to execute on the client device.

9. The system of claim 1, the client-side deployment component configured to maintain the client context on the client device.

10. The system of claim 1, the client-side deployment component configured to restrict disclosure of the client context to the remote source.

11. The system of claim 1, the remote source comprising an app deployment service.

12. The system of claim 1, the first set of flight distribution criteria specifying that the first flight version of the application package is an experimental version of the application package.

13. The system of claim 1, the client-side deployment component hosted by an operating system as an operating system component.

14. A method for client-side flight version acquisition, comprising:
identifying an application package available for retrieval from a remote source;
retrieving a flight description for the application package from the remote source to a client device, the flight description comprising a first set of flight distribution criteria for a first flight version of the application package and a second set of flight distribution criteria for a second flight version of the application package;
invoking, on the client device, a set of filtering modules to filter the flight description based upon a client context to identify a qualifying flight version of the application package;
acquiring the qualifying flight version of the application package from the remote source to the client device; and
deploying the qualifying flight version of the application package on the client device.

15. The method of claim 14, comprising:
restricting disclosure of the client context to the remote source.

16. The method of claim 14, comprising:
identifying the client context based upon at least one of a hardware configuration of the client device, a software configuration of the client device, or descriptive user information of a user of the client device.

17. The method of claim 14, the invoking comprising:
invoking a probabilistic filtering module to filter the flight description.

18. The method of claim 14, the invoking comprising:
invoking a user characteristic filtering module to filter the flight description.

19. The method of claim 14, the invoking comprising:
invoking a device configuration filtering module to filter the flight description.

20. A computer readable medium comprising instructions which when executed perform a method for client-side flight version acquisition, comprising:
identifying an application package available for retrieval from a remote source;
retrieving a flight description for the application package from the remote source to a client device, the flight description comprising a first set of flight distribution criteria for a first flight version of the application package and a second set of flight distribution criteria for a second flight version of the application package;
identifying a client context based upon at least one of a hardware configuration of the client device, a software configuration of the client device, or descriptive user information of a user of the client device;
restricting disclosure of the client context to the remote source;
invoking, on the client device, a set of filtering modules to filter the flight description based upon the client context to identify a qualifying flight version of the application package;
acquiring the qualifying flight version of the application package from the remote source to the client device; and
deploying the qualifying flight version of the application package on the client device.
